(19) United States
(12) Patent Application Publication
(10) Pub. No.: US 2008/0238276 A1
(43) Pub. Date: Oct. 2, 2008

(54) Hinge Assembly for the Articulated Connection of a Vertically Opening Panel to a Furniture Element

(76) Inventor: Carlo Migli, Lecco (IT)

Correspondence Address: SUGHRUE MION, PLLC, 2100 PENNSYLVANIA AVENUE, N.W., SUITE 800, WASHINGTON, DC, 20037, US

(21) Appl. No.: 10/575,258

(22) PCT Filed: Oct. 8, 2004
(86) PCT No.: PCT/EP04/11434

§ 371 Date: Apr. 10, 2006

(51) Int. Cl. E05F 1/06; E05D 5/06; E05F 1/08; A47B 96/00

(52) U.S. Cl. 312/326; 16/310; 16/277

(57) ABSTRACT

A hinge assembly (1) is described for the articulated connection of a vertically opening panel (2) to a furniture element (3) between a closing position and an opening position in which the panel (2) is at least partially lifted with respect to the hinge assembly (1) and to the furniture element (3). More specifically, the hinge assembly (1) comprises: —a supporting base (6); —a lifting lever (7) operatively connected to the panel (2) and hinged to the supporting base (6) about a pivoting axis (P1-P1) between the closing and opening positions of the panel (2); —a balancing device (10) acting on the lifting lever (7) to at least partially counterbalance the weight of the panel (2) during rotation of the lever (7) about the pivoting axis (P1-P1). According to the invention, in the mounting position of the hinge assembly (1) the pivoting axis (P1-P1) of the lifting lever (7) and the balancing device (10) are positioned above an upper surface (4a) of the furniture element (3).

### FIELD OF THE INVENTION

In a general aspect thereof, the present invention relates to a hinge assembly for the articulated connection of a vertically opening panel to a furniture element.

The present invention relates, in particular, to a hinge assembly as defined by the preamble of the attached claim 1.

Within the framework of the present description and in the subsequent claims, the term: panel, is used to indicate a suitable element, generally substantially plate-shaped, such as for example a shutter or a door, articulated to a furniture element so as to close at least in part at least one space of the furniture element, which in turn can be a cupboard, such as for example the so-called wall-cupboards normally installed in kitchens.

### PRIOR ART

In the field of hinge assemblies for vertically opening panels of this type, hinges of articulated parallelogram type, which are adapted to move the panel along a vertical direction with translation and rotation movements combined together so as to completely free the access opening to the inside of the cupboard, are known.

Such hinges are mounted inside the cupboard and essentially comprise a supporting base, laterally fixed to one sidewall of the cupboard, and a pair of lifting levers operatively connected to the panel by means of at least one fastening element, each one of the lifting levers being hinged about two substantially horizontal pivoting axes, defined at the supporting base and at the fastening element.

In this way, the panel is articulated to the furniture element between a closing position in which the panel is generally arranged along a substantially vertical direction and an opening position in which the panel is at least partially lifted with respect to the hinge and the cupboard.

In order to ease the lifting of the panel by the user, these hinges are also provided with a balancing device, generally of the spring type, acting on at least one of the lifting levers to at least partially counterbalance the weight of the panel during rotation of the levers about the aforementioned pivoting axes.

Although substantially achieving their purpose, hinges of this type do, however, possess some drawbacks which have yet to be given an adequate solution.

A first drawback of known articulated quadrilateral type hinges is linked to the need of providing sufficient space inside the furniture element to receive each hinge, which in the closing position of the panel must be completely received inside the cupboard.

The size of such receiving space—clearly unusable for other purposes—is, however, far from being negligible.

The lifting levers, in fact, must be sufficiently long to allow a proper rotation-translation movement of the panel, which in almost all cases gives rise to a total height of the closed hinge which is greater than half the total height of the cupboard itself. It derives not only a reduction of useful space near the sidewalls of the cupboard, but also that the shelves for dividing the space inside the cupboard must be out so as to receive the hinge, with a consequent higher production cost and, above au, with a further significant reduction in useful space, i.e. with a reduction of the storage capacity of the cupboard.

An additional drawback of known articulated quadrilateral type hinges is linked to the problems which occur whenever relatively large panels (for example having a width greater than 60 centimeters) are to be lifted.

The mounting operations of the hinge to the sidewall of the cupboard, in fact, require the use of two hinges per each panel, which hinges, although strong, are not always capable to ensure a correct alignment of the panels in the opening position if the panels are relatively large in size.

In fact, it has been noted that with this type of hinge larger panels can flex in their central part under the effect of their own weight when they are in such a position.

Whenever relatively large panels are to be articulated to the cupboard, moreover, it is necessary to use a particularly sturdy balancing device with a further reduction in useful space near the sidewalls of the cupboard and with an undesired increase of production costs.

### SUMMARY OF THE INVENTION

The technical problem underlying the present invention is, therefore, that of providing a hinge assembly for vertically opening panels having structural and functional features capable to at least partially overcome the aforementioned drawbacks mentioned with reference to the cited prior art.

According to the invention, this problem is solved by a hinge assembly as defined in the attached claim 1.

Thanks to the combination of features defined in such a claim, the hinge assembly of the invention is capable to achieve the desired opening along the vertical direction of the panel in an extremely simple and effective manner while being advantageously positionable outside of the furniture element and, in particular, above the same.

According to the present invention, this advantageous technical effect can be achieved thanks to the fact that in the mounting position of the hinge assembly the pivoting axis of the lifting lever and the balancing device are both positioned above an upper surface of the furniture element.

In other words, this means that in the mounting position of the hinge assembly there is no structural element of the furniture element above the lifting lever and above the balancing device.

The external arrangement of the hinge assembly allows in turn to exploit all of the space inside the furniture element, so that possible intermediate shelves can be made having the same depth as the furniture element itself.

Advantageously, the hinge assembly of the invention is out of the user's sight when it is installed above a sufficiently tall furniture element or above a furniture element which is positioned sufficiently high, such as for example in the case of so-called kitchen wall-cupboards, so as not to alter the aesthetic characteristics of the cupboard.

The hinge assembly of the invention, moreover, advantageously allows to definitively overcome the intrinsic limitations linked to the use of two hinge assemblies for each panel as happens for known articulated quadrilateral type hinges.

Thus, for example, the hinge assembly of the invention can allow the useful space defined within the furniture element to be divided up as desired forming variously distributed spaces both along the vertical and the horizontal directions with a single closing panel having a size capable to cover the entire width of the cupboard.

The size of the panel, therefore, no longer constitutes a limitation neither in terms of alignment, nor in terms of weight, since it is sufficient to mount a suitable number of hinge assemblies above the cupboard, exactly as happens for conventional hinges having a vertical rotation axis for the articulation of a horizontally opening door to a piece of furniture.

In the case of large panels, the hinge assembly of the invention could also be motorized in a much simpler way than known hinges of the articulated quadrilateral type, for which the motorization is complex and difficult to fit in since the electric actuation motor must also be housed inside the piece of furniture.

Preferred features and embodiments of the hinge assembly according to the present invention, which shall be illustrated in greater detail hereinafter, are defined in the attached dependent claims 2-36 the content of which is herein integrally incorporated.

According to a second aspect thereof, defined in the attached claim 37, the present invention refers to a furniture element comprising a vertically opening panel articulated thereto by means of at least one hinge assembly as defined above.

Additional features and preferred embodiments of the furniture element according to the present invention, which shall be illustrated in greater detail hereinafter, are defined in the attached dependent claims 38-40 the content of which is herein integrally incorporated.

Clearly, the advantageous features of the hinge assembly object of the present invention give rise to as many advantageous features of the furniture element in which the hinge assembly can be mounted as shall become clear in the following description.

### BRIEF DESCRIPTION OF THE DRAWINGS

Additional features and advantages of the invention shall become clearer from the following description of preferred embodiments thereof given hereinafter, for illustrating and not limiting purposes, with reference to the attached drawings. In such drawings:

FIG. 1 shows a perspective view, partially in section, of a first preferred embodiment of the hinge assembly according to the invention for the articulated connection of a vertically opening panel to a furniture element, and in which the panel is arranged in an opening position;

FIG. 2 shows a longitudinal section view of the hinge assembly of FIG. 1 in a closing position of the panel;

FIG. 3 shows a longitudinal section view of the hinge assembly of FIG. 1 in the opening position of the panel;

FIG. 4 shows an enlarged longitudinal section view of some details of the hinge assembly of FIG. 1 in a first adjusting condition thereof;

FIG. 5 shows an enlarged longitudinal section view of some details of the hinge assembly of FIG. 1 in a second adjusting condition thereof;

FIG. 6 shows a perspective exploded view of the hinge assembly of FIG. 1;

FIG. 7 shows a longitudinal section view of a second preferred embodiment of the hinge assembly according to the invention in the closing position of the panel;

FIG. 8 shows a longitudinal section view of the hinge assembly of FIG. 7 in the opening position of the panel;

FIG. 9 shows a perspective exploded view of the hinge assembly of FIG. 7;

FIG. 10 shows a side view of a third preferred embodiment of the hinge assembly according to the invention in a partially opening position of the panel;

FIG. 11 shows a side view of the hinge assembly of FIG. 10 in the closing position of the panel;

FIG. 12 shows a top partial section view of the hinge assembly of FIG. 10 in the closing position of the panel;

FIGS. 13 and 14 show two enlarged perspective views of some details of a further embodiment of the hinge assembly of FIGS. 1 and 7.

### DETAILED DESCRIPTION OF THE PREFERRED EMBODIMENTS

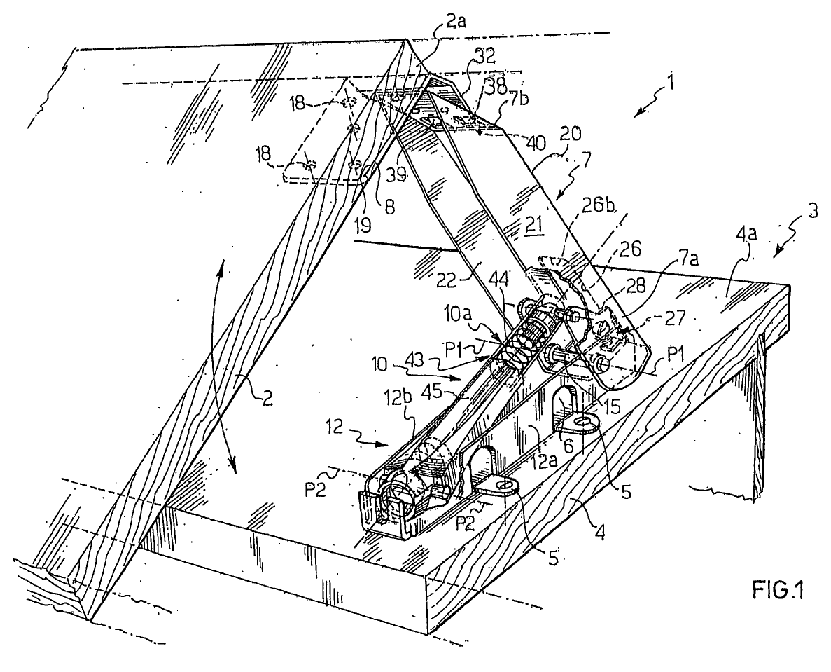

With reference to FIGS. 1-6, a first preferred embodiment of a hinge assembly according to the invention for the articulated connection of a vertically opening panel 2 to a furniture element 3 is generally indicated at 1.

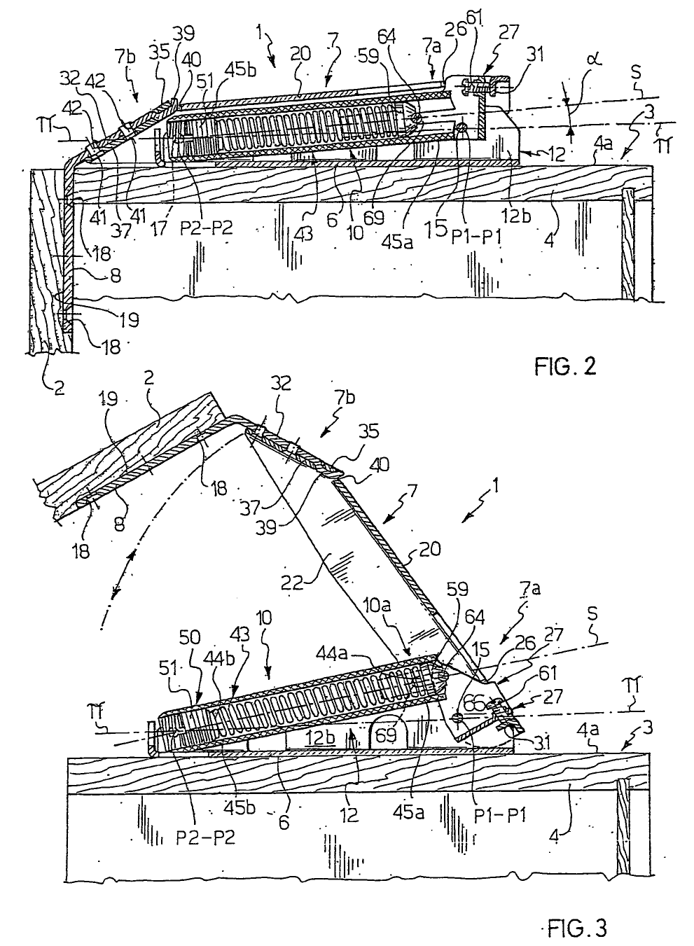

Specifically, the panel 2 is articulated to the furniture element 3 between a closing position (illustrated for example in FIG. 2) in which the panel 2 is preferably arranged along a substantially vertical direction and an opening position (illustrated for example in FIG. 3) in which the panel 2 is at least partially lifted with respect to the hinge assembly 1 and to the furniture element 3.

For purely illustrating purposes, the furniture element 3 can for example be a so-called wall-cupboard that can be installed in a kitchen or a small cupboard adapted to be arranged in a camper, whereas the panel 2 can be a door for closing the aforementioned wall-cupboard or small cupboard.

The hinge assembly 1 is mounted on an upper surface 4a of the furniture element 3 defined by the outer face of an upper wall 4 of the furniture element 3 to, which the hinge assembly is fixed in a way known per se, for example by means of a plurality of fastening screws 5.

The hinge assembly 1 comprises a fixed part, essentially constituted by a supporting base 6, and a mobile part including a lifting lever 7, a balancing device 10 and, possibly, an angular adjustment device 27, which shall be described in greater detail hereinafter.

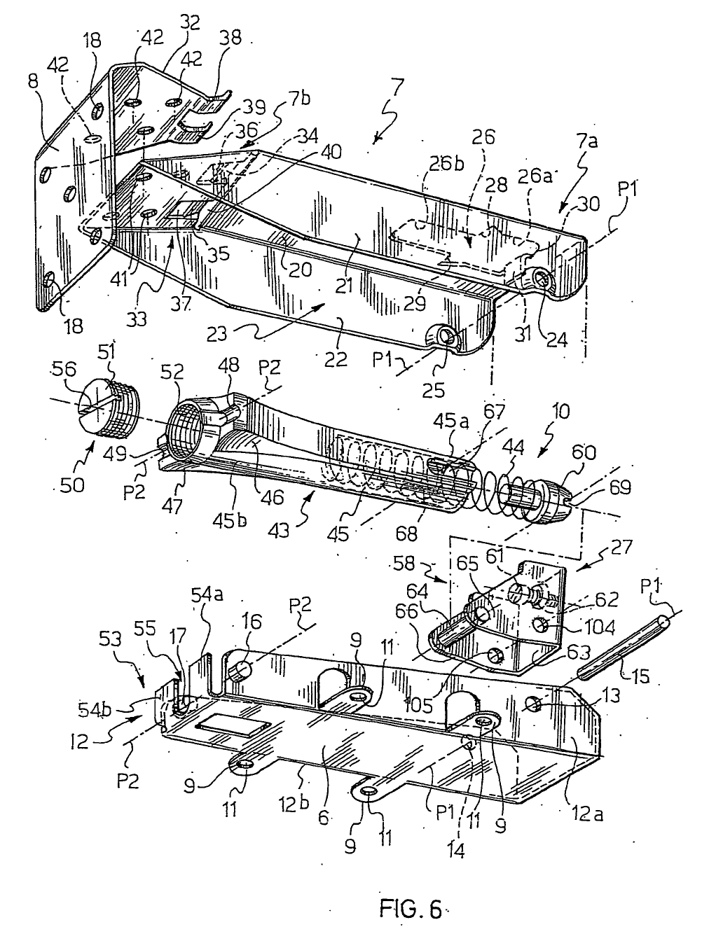

Preferably, the supporting base 6 is essentially constituted by a bottom wall of a supporting element 12 having a substantially C-shaped cross-section and being advantageously made of a suitable structural material, for example a metal, which can be shaped into the desired shape by means of conventional plastic deformation and shearing operations (see FIG. 6).

In the preferred embodiment illustrated, the supporting base 6 is provided with a plurality of tangs 9, preferably formed by shearing from opposite side walls 12a, 12b of the supporting element 12, in which tangs through-holes 11 are formed which are engaged by the screws 5 for fastening the hinge assembly 1 to the upper wall 4 of the furniture element 3.

Preferably, the side walls 12a, 12b of the supporting element 12 are provided—at a first end portion proximal to the lifting lever 7—with respective through-holes 13, 14 for receiving a pin 15, transversely extending in the supporting element 12 and defining a pivoting axis P1-P1, preferably substantially horizontal, for the lever 7.

In this way, the lifting lever 7 is hinged to the supporting base 6 about the pivoting axis P1-P1 between the aforementioned closing and opening positions of the panel 2.

In the preferred embodiment illustrated, moreover, the side walls 12a, 12b of the supporting element 12 are provided—at a second end portion distal from the lifting lever 7—with respective pins 16, 17, extending in a cantilevered fashion from the walls 12a, 12b towards the inside of the supporting element 12 and defining a pivoting axis P2-P2, preferably substantially horizontal, for the balancing device 10.

Preferably, the pivoting axis P2-P2 is also substantially parallel to the pivoting axis P1-P1 with which it defines a dead centre plane π, i.e. that plane which defines the condition of maximum compression of the balancing device 10, as shall become clearer in the following description.

In the preferred embodiment illustrated, the lifting lever 7 is operatively connected to the panel 2 by means of a fastening element 8 associated to the panel itself.

According to a feature of the invention, both the balancing device 10 and the pivoting axis P1-P1 of the lifting lever 7 are positioned above the upper surface 4a of the furniture element 3 in the mounting position of the hinge assembly 1, as illustrated for example in FIG. 2.

Preferably, moreover, the balancing device 10 and the lifting lever 7 are both mounted above the supporting base 6.

In the preferred embodiment illustrated, the fastening element 8 is essentially constituted by a substantially plate-shaped element.

In this way, it is advantageously possible to have an adequate contact surface between the fastening element 8, which performs the function of operatively connecting the lifting lever 7 to the panel 2, and the lever itself so as to have a stable and secure coupling to the panel.

Clearly, the plate configuration of the fastening element 8 is just a possible and preferred embodiment, so that those skilled in the art may select other equally advantageous shapes in order to comply with specific application requirements.

Preferably, the fastening element 8 is also laterally associated to the panel 2 at an upper end 2a thereof so as to reduce to a minimum the extension of the operative part of the hinge assembly 1 associated to the panel 2 whilst still having an effective action on the panel itself.

In the preferred embodiment illustrated, the substantially plate-shaped fastening element 8 is fixed to the panel 2 by means of a plurality of fastening screws conventional per se, not shown, received in respective through-holes 18 formed in the fastening element 8.

Preferably, the substantially plate-shaped fastening element 8 is also received in a respective housing seat 19 laterally formed at the upper end 2a of the panel 2.

As illustrated in FIG. 2, it is thus advantageously possible to obtain a flush closing of the panel 2 taking into account the thickness of the substantially plate-shaped element 8.

In the preferred embodiment illustrated in FIGS. 1-6, the lifting lever 7 has a C-shaped cross-section and is also advantageously made of a suitable structural material, for example a metal, which can be shaped into the desired shape by means of conventional plastic deformation and shearing operations.

In the preferred embodiment illustrated, the lifting lever 7 therefore comprises a central wall 20 from which opposite side walls 21, 22—forming an angle of about 90° with the central wall 20—are integrally extending.

Preferably, the width of the central wall 20 of the lifting lever 7 is slightly greater than the overall width of the supporting base 6 defined in the supporting element 12 so that the lever 7 is capable to house the supporting element 12 when the hinge assembly 1 is in the closing position illustrated in FIG. 2.

Advantageously and as shall become clearer hereinafter, such a preferred configuration of the lifting lever 7 thus allows to define within the lever itself a housing space 23 in which other elements of the hinge assembly 1 can also be housed, such as for example the balancing device 10, at least in the closing state illustrated in FIG. 2.

In such a position, the lifting lever 7 and the supporting element 12 therefore define a sort of boxed containment structure.

The lifting lever 7 is advantageously provided, at the pivoting axis P1-P1 defined by the pin 15, with a pair of through-holes 24, 25 formed in the side walls 21, 22 of the lever coaxially with the through-holes 13, 14 formed in the opposite side walls 12a, 12b of the supporting element 12.

In this way, the pin 15 is capable to engage both the through-holes 13, 14 of the supporting element 12, and the through-holes 24, 25 of the lifting lever 7 thus determining the pivoting thereof about the axis P1-P1.

Preferably, the central wall 20 of the lifting lever 7 is also provided—at a portion 7a thereof proximal to the pivoting axis P1-P1—with a suitably shaped opening 26, adapted to at least partially receive the angular adjustment device 27—which shall be illustrated hereinafter—adapted to adjust the angular positioning of the point of application of the thrust exerted by the balancing device 10 on the lifting lever 7 with respect to the pivoting axis P1-P1 of the lever itself or, in other words, the direction of thrust S of the balancing device 10 with respect to the dead centre plane π passing through the pivoting axes P1-P1 and P2-P2.

Preferably, the opening 26 is formed in the central wall 20 of the lifting lever 7 by means of conventional shearing operations and longitudinally extends in the portion 7a of the lifting lever 7 for a portion of predetermined length near the pivoting axis P1-P1.

Preferably, the opening 26 comprises two longitudinally adjacent portions having different widths and, to be precise, a portion 26a having a larger width, formed close to the pivoting axis P1-P1 and a portion 26b having a smaller width longitudinally extending from the portion 26a at a side opposite to said axis (see FIG. 6).

Advantageously, in this way two transversal edges 28, 29, preferably substantially rectilinear and located at opposite sides of the portion 26b, are defined in the portion 26a having a larger width of the opening 26, which transversal edges 28, 29 are adapted to constitute—as will become clearer later on—as many abutment means for limiting the angular displacement of the angular adjustment device 27 with respect to the lifting lever 7.

Preferably, the opening 26 is also provided—at a transversal edge 30 of the portion 26a opposite to the edges 28, 29—with a tang 31 integrally extending from the central wall 20 of the lifting lever 7.

Advantageously, the tang 31 forms an angle of about 90° with the central wall 20 and extends in the space 23 defined within the lifting lever 7 so as to constitute—as will become clearer later on—an additional abutment means for limiting the angular displacement of the angular adjustment device 27 with respect to the lifting lever 7.

Preferably, the lifting lever 7 is associated to the fastening element 8 associated to the panel 2 by means of a connecting arm 32 which—in the preferred embodiment illustrated in FIGS. 1-6—is preferably integrally formed with the fastening element itself.

In this preferred embodiment, the connecting arm 32 is of the plate-shaped type and is substantially L-shaped, whereas the fastening element 8 is in particular preferably constituted by a portion of the connecting arm 32 distal with respect to the lifting lever 7.

In the preferred embodiment illustrated, moreover, the connecting arm 32 is removably associated to the lifting lever 7 by means of the engagement between suitable hooking means 33 formed at an end portion 7b of the lever distal with respect to the pivoting axis P1-P1 and a portion of the connecting arm 32 proximal to the lever itself.

Preferably, the hooking means 33 comprises a pair of substantially bridge-shaped retaining elements 34, 35, formed in the end portion 7b of the lifting lever 7 at an end of corresponding openings 36, 37 also formed in the aforementioned end portion 7b.

The openings 36, 37 are in turn intended to receive, preferably with substantial shape coupling, respective hooking projections 38, 39 extending from an end of the connecting arm 32 proximal to the lifting lever 7.

Preferably, the hooking means 33 further comprises an elongated opening 40, transversely extending in the lifting lever 7 proximate to the retaining elements 34, 35, and intended to receive the free ends of the hooking projections 38, 39 in the mounting condition of the connecting arm 32 to the lifting lever 7 (see FIGS. 1-3).

In the preferred embodiment illustrated, the elongated opening 40 also constitutes a separation element between the end portion 7b of the lifting lever 7 from the remaining part of the lever and, in particular, from the central wall 20 thereof with respect to which it preferably forms an obtuse angle of predetermined value.

Thanks to the configuration described above, the connecting arm 32 can be stably associated to the lifting lever 7 and ensure a reliable operation of the hinge assembly 1 during the movement of the panel 2.

Preferably, the end portion 7b of the lifting lever 7 distal with respect to the pivoting axis P1-P1 and the portion of the connecting arm 32 proximal to the lever itself have substantially the same inclination with respect to the central wall 20 of the lifting lever 7 and have substantially the same width.

In this way, it is advantageously possible to achieve an optimal transmission of the lifting force—which is spread out over a relatively wide surface—exerted by the lever 7 to the connecting arm 32 and, by means of the latter, to the fastening element 8 during the movement of the panel 2.

By suitably selecting the aforementioned inclination of the adjacent and cooperating end portions of the lifting lever 7 and of the connecting arm 32 it is also advantageously possible to achieve a correct closure of the panel 2, so as to ensure the desired verticality of the panel and/or perpendicularity with the upper wall 4 of the furniture element 3 (see FIG. 2).

In the preferred embodiment illustrated, the hooking means 33 adapted to removably associate the connecting arm 32 to the lifting lever 7 further comprises a plurality of screws or bolts, conventional per se and not shown, received in a corresponding plurality of through-holes 41, 42 for housing the same, respectively formed in the adjacent cooperating end portions of the lifting lever 7 and of the connecting arm 32.

Clearly, just one possible embodiment of the lifting lever 7, of the connecting arm 32 and of the hooking means 33 is illustrated in FIGS. 1-6, the man skilled in the art being capable to select other possible embodiments in order to satisfy specific application requirements.

Thus, in alternative embodiments, the connecting arm 32 can for example be integrally formed with the lifting lever 7 and/or be in turn an element structurally independent from the fastening element 8, so as to be removably associable to such an element in a way known per se.

As stated above, in the hinge assembly 1 of the invention the weight of the panel 2 is counterbalanced during rotation of the lifting lever 7 by a balancing device 10 acting on the lever 7 to ensure a lifting of the panel 2 with a minimum effort by the user.

In the preferred embodiment illustrated in FIGS. 1-6, the balancing device 10 comprises a spring group 43 made in such a way as to exert a thrusting action on the lifting lever 7 capable to at least partially counterbalance the weight of the panel 2 during rotation of the lever about the pivoting axis P1-P1.

Preferably, the spring group 43 comprises at least one spring 44, preferably of the coil type, received in a longitudinal hole 52 formed in the hollow supporting body 45. Such a hollow body 45 is preferably tubular in shape and, even more preferably, substantially cylindrical.

The spring 44 comprises a first thrusting end 44a, acting on a pushing element 59—preferably frusto-conical in shape—slidably mounted in a hollow body 45 and adapted to cooperate with the angular adjustment device 27 operatively arranged between the balancing device 10 and the lifting lever 7, as will become clearer in the following.

The spring 44 also comprises a second reaction end 44b, reacting on a closing cap 51 of an end portion 45b of the hollow body 45 which is distal with respect to the lifting lever 7.

In this way, the pushing element 59 is urged by the coil spring 44 towards the lifting lever 7 to which the pushing element 59 transmits the g action of the balancing device 10 according to the operations that will be described in greater detail hereinafter.

Preferably, the spring group 43 comprises at least one spring-guiding stem 60 extending from the pushing element 59 and inserted in the thrusting end 44a of the spring 44 to ease its correct expansion/compression movement along the direction of thrust S exerted by the balancing device 10.

Preferably, the hollow body 45, the cap 51 and the pushing element 59 are made of a suitable plastics material so as to advantageously reduce both weight and production cost thereof.

In order to ensure that the balancing device 10 exerts a correct thrusting action during the entire rotation arc of the lifting lever 7 about the pivoting axis P1-P1 during the movement of the panel 2, the hollow body 45 is preferably hinged to the supporting base 6 at its end portion 45b distal with respect to the lifting lever 7.

In the preferred embodiment illustrated in FIGS. 1-6, the hollow body 45 is hinged to the pins 16, 17—laterally extending in a cantilevered fashion from the walls 12a, 12b of the supporting element 12 on either side of the supporting base 6—so as to be rotatable about the pivoting axis P2-P2 defined by the aforementioned pins.

To this end, the hollow body 45 is preferably provided with a pair of projections 46, 47 radially extending from the end portion 45b and provided with respective seats 48, 49 for rotatably receiving the pins 16, 17 during the movement of the panel 2 articulated to the furniture element 3 by means of the hinge assembly 1 (see FIG. 6).

Preferably, the balancing device 10 comprises an adjustment device 50 for adjusting the thrusting force exerted by the same on the lifting lever 7.

In the preferred embodiment illustrated in FIGS. 1-6, the adjustment device 50 comprises the cap 51 for closing the end portion 45b of the hollow body 45, said cap in this case being able to be adjustably positioned along the longitudinal direction to move the abutment zone of the reaction end 44b of the spring 44.

Preferably, the cap 51 is externally threaded and in screwing engagement in a corresponding treaded end of the longitudinal hole 52 formed in the hollow body 45 and housing the spring 44.

In this way, it is advantageously possible to adjust the thrusting force exerted by the balancing device 10 on the lifting lever 7 by simply screwing or unscrewing the cap 51 into/from the hole 52, i.e. by adjusting the degree of compression of the spring 44.

To this end, the cap 51 is preferably provided with a groove 56 or another type of notch, adapted to be engaged by the tip of a suitable tool, for example a screwdriver, for screwing or unscrewing the cap 51.

Preferably, the hinge assembly 1 further comprises an abutment element 53 adapted to limit the extraction of the closing cap 51 from the end 45b of the hollow body 45 which houses the spring 44.

In this way, it is advantageously possible to prevent that accidental maneuvers, an incorrect operation or a failure of the adjustment device 50 may cause that the mobile element of such a device, i.e. the cap 51, is thrown out of the hinge assembly 1 with possible serious harm to the user.

In the preferred embodiment illustrated in FIGS. 1-6, the abutment element 53 is substantially constituted by a pair of tangs 54a, 54b integrally extending from the supporting base 6 and, as such, forming part of the supporting element 12.

Preferably, the aforementioned tangs 54a, 54b are spaced apart in the transversal direction, so as to define a slit 55 adapted to allow the introduction of a suitable tool, for example a screwdriver, to screw or unscrew the cap 51.

According to a preferred feature of the invention and as stated above, the balancing device 10 is at least temporarily housed in the housing space 23 defined within the lifting lever 7 during rotation of the latter about the pivoting axis P1-P1.

In the preferred embodiment illustrated in FIGS. 1-6, the balancing device 10 is, in particular, substantially completely housed in the housing space 23 in the closing position of the panel 2 (see FIG. 2) and gradually comes out of such a space as the lifting lever 7 rotates about the axis P1-P1, i.e. as the panel 2 moves upwards.

It ensues that in a position of complete opening illustrated in FIG. 3, just an end portion 10a of the balancing device 10 proximal to the pivoting axis P1-P1 is still housed in the space 23.

According to a further preferred feature of the invention and as stated above, the hinge assembly 1 further comprises an angular adjustment device 27 for adjusting the angular positioning of the direction of thrust S exerted by the balancing device 10 on the lifting lever 7 with respect to the horizontal plane π passing through the pivoting axis P1-P1.

Preferably, the angular adjustment device 27 is operatively arranged between the lifting lever 7 and the balancing device 10 and, as such, receives from the latter the thrust exerted by the same and directed towards the lifting lever 7.

In the illustrated embodiment, the angular adjustment device 57 comprises a substantially fork-shaped supporting body 58, provided with a central wall 63 and with two wings 65, 66 extending in a cantilevered fashion from and substantially perpendicular to the central wall 63.

Preferably, the supporting body 58 is hinged to the supporting base 6 about a pivoting axis P1-P1 of the lifting lever 7 so as to be angularly displaceable with respect to the latter.

In the embodiment illustrated in FIGS. 1-6, this is obtained thanks to the engagement of the pin 15 in respective through holes 104, 105 for housing the same formed in the wings 65, 66 of the supporting body 58 (see FIG. 6).

Preferably and in order to regulate in an adjustable manner the angular positioning of the supporting body 58 with respect to the lifting lever 7, the angular adjustment device 27 comprises suitable adjustment means, for example constituted by a screw 61 in screwing engagement in a respective hole 62 formed, preferably at a central position, in the central wall 63 of the supporting body 58.

Preferably, the hinge assembly 1 of the invention further comprises abutment means for limiting the angular displacement of the supporting body 58 of the angular adjustment device 27 with respect to the lifting lever 7.

In the preferred embodiment illustrated in FIGS. 1-6, this abutment means is constituted, on one side, by the substantially rectilinear transversal edges 28, 29 of the opening 26 positioned on opposite sides of the portion 26b thereof and, on the other side, by the tang 31 integrally extending from the central wall 20 of the lifting lever 7.

According to a preferred embodiment of the invention, the angular adjustment device 27 is provided with a pin 64—transversely mounted in the supporting body 58 between its wings 65, 66—on which pin the balancing device 10 is acting in this case by means of the pushing element 59.

Preferably, the pin 64 is slidably mounted along the longitudinal direction in an end portion 45a of the hollow body 45 of the spring group 43 proximal to the lifting lever 7 during the rotation of the latter about its pivoting axis P1-P1.

In this preferred embodiment, the hollow body 45 of the balancing device 10 is advantageously provided with means for guiding the longitudinal sliding of the pin 64, which guiding means is in this case essentially constituted by a pair of grooves 67, 68 formed in the end portion 45a of the hollow body 45 from a free end thereof and longitudinally extending for a portion of predetermined length.

Advantageously, the grooves 67, 68 constitute respective tracks for the guided sliding of the pin 64 during the opening and closing movement of the hinge assembly 1 which movement involves, as will become clearer hereinafter, a relative movement between the balancing device 10 and the lifting lever 7.

In this preferred embodiment, finally, the pushing element 59 which constitutes the element of the balancing device 10 cooperating with the angular adjustment device 27, is advantageously provided with a transversal groove 69 in which the pin 64 is rotatably received, preferably with shape coupling.

In this way, the spring group 43 of the balancing device 10 is advantageously free to rotate relative to the pin 64 which is, on the other hand, rotatably connected to the lifting lever 7 during the movement of the panel 2.

Thanks to the preferred features described above, the angular adjustment device 27 is therefore also housed in the housing space 23 defined within the lifting lever 7, with an advantageous reduction of the overall size of the hinge assembly 1 in its closed state (see FIG. 2).

Advantageously and as stated above, the angular adjustment device 27 allows to adjust the angular positioning of the point of application of the thrust exerted by the balancing device 10 on the lifting lever 7 with respect to the pivoting axis P1-P1 of the lever itself or, in other words, to adjust the direction of thrust S of the balancing device 10 with respect to the dead centre plane π passing through the pivoting axes P1-P1 and P2-P2.

According to a preferred feature of the invention, the aforementioned adjustment is carried out by the angular adjustment device 27 in the closing position of the hinge assembly 1 illustrated in FIG. 2, which position will be indicated hereinafter with the term: adjustment position of the hinge assembly.

Preferably, the direction of thrust S of the balancing device 10—defined by the line joining the pivoting axis P2-P2 of the balancing device 10 and the axis of the pin 64 of the angular adjustment device 27—can be adjusted in the aforementioned adjustment position of the hinge assembly so as to preferably form an angle α of from about 0° to about 30° with respect to the aforementioned dead centre plane π.

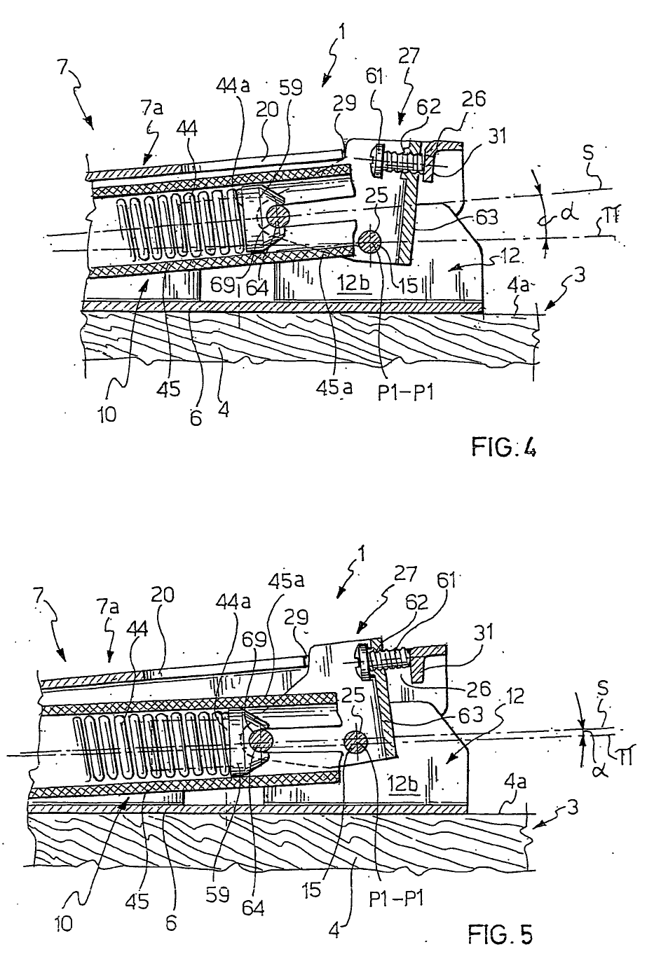

This adjustment can be advantageously obtained by acting on the screw 61, which causes a rotation about the pin 15 of the supporting body 58 of the angular adjustment device 27 between two opposite uppermost and lowermost adjustment conditions illustrated in FIGS. 4 and 5.

Advantageously, the angular adjustment device 27 thus allows to adjust the direction of thrust S of the balancing device 10 by moving this direction closer to or away from the dead centre plane π at which the maximum compression of the spring group 43 is achieved, which dead centre plane π comprises the pivoting pins 16, 17 of the spring group 43 and the pin 15 about which the lifting lever 7 rotates.

In this way, the angular adjustment device 27 advantageously allows to adjust the L 5 counteraction carried out by the spring group 43 that counterbalances the weight of the panel 2 in the closing position by adjusting the “retention” force of the panel itself.

In a particularly preferred embodiment of the invention and as illustrated in FIGS. 1-6, it is preferable to make the hinge assembly 1 in such a way that also in the lowermost adjustment condition (see FIG. 5) the direction of thrust S of the balancing device 10 is never below the dead centre plane π.

In this way, it is possible to achieve two important advantages.

A first advantage is constituted by the fact that in this way it is possible not only to have a very regular operation of the hinge assembly 1, without jerks or variations in the thrusting action during the movement of the panel 2, but also to achieve a “self-supporting” effect of the panel 2 at any intermediate opening position, an effect which is highly desirable by furniture-makers.

A second advantage, on the other hand, is linked to the safety increase of the hinge assembly 1. Unlike known articulated quadrilateral type hinges, in fact, the spring group 43 of the balancing device 10 does not have in this preferred embodiment any dead centre, for which reason it always thrusts in a single direction with an advantageous stability increase of the hinge assembly 1. The latter, therefore, can be sent open to the furniture-maker who may install the same on the piece of furniture without any danger and can only be closed after having associated the fastening element 8 to the panel 2 without any danger of a sudden opening or closing (shearing effect) of the spring group 43/lifting lever 7 assembly.

From what has been outlined hereinabove the adjusting and operating modes of this preferred embodiment of the hinge assembly 1 according to the invention are also immediately clear.

In an adjusting mode, carried out when the hinge assembly is closed as illustrated in FIGS. 4 and 5, the user or the furniture-maker are able both to adjust the “retention” force of the panel 2 exerted by the hinge assembly 1 during the opening and closing movements thereof by means of the angular adjustment device 27 (by acting on the screw 61), and to adjust the force with which the hinge assembly 1 counterbalances the weight of the panel 2 by adjusting the degree of compression of the spring 44 by means of the adjustment device 50 (by acting on the cap 51).

Once the optimal adjustment of the hinge assembly 1 has been obtained according to the type and weight of the panel 2 to be articulated to the furniture element 3, the user should simply slightly lift the panel 2 to automatically trigger the operation of the hinge assembly 1.

The balancing device 10, in fact, immediately carries out its thrusting action on the lifting lever 7 acting on the angular adjustment device 27 as soon as the user lifts the panel 2 and continues its thrusting action during the entire opening or closing movement of the panel 2 which in this case is essentially a rotation movement.

It should be noted in this respect that the angular adjustment device 27 is rotatably connected to the lifting lever 7 towards which the device is urged by the spring group 43 during the movement of the panel 2, whereas the balancing device 10 rotates about its pivoting axis P2-P2.

During the lifting of the panel 2, moreover, the lifting lever 7 rotates about the pivoting axis P1-P1 and receives from the balancing device 10 a thrusting action which can be adjusted by the user in order to counterbalance the weight of the panel itself.

By suitably adjusting the balancing device 10, in fact, the rusting action exerted by the same can be capable of substantially completely counterbalancing the weight of the panel 2 so that the user only has to apply a light lifting action to move the panel 2 upwards.

During such a movement, the panel 2 passes from a closing position of the furniture element 3 in which both the pivoting axis P1-P1 of the lifting lever 7 and the balancing device 10 are positioned above the upper surface 4a of the furniture element 3 (see FIG. 2), to an opening position in which the panel 2 is at least partially lifted with respect to the hinge assembly 1 and to the furniture element 3 (see FIG. 3).

Advantageously, the relative movements between the balancing device 10 and the lifting lever 7 during rotation of both these elements are balanced at any angular position taken up by the panel 2 thanks to the engagement of the pin 64 in the transversal groove 69 formed in the pushing element 59 and thanks to the guided sliding thereof in the grooves 67, 68 formed at the end 45a of the hollow body 45.

The articulation of the panel 2 to the furniture element 3 is therefore capable to ensure a very regular movement of the panel 2 as is currently required by the market.

Clearly and with the aim of reducing the cost of the hinge assembly 1 described above, it is possible to foresee the total elimination of the angular adjustment device 27, which, as stated above, constitutes an optional element of the hinge assembly itself.

In this simplified preferred embodiment of the hinge assembly 1, the pin 64 is directly fixed between the side walls 21, 22 of the lifting lever 7 once the optimal value of the angle α has been identified for the specific hinge assembly 1/panel 2 configuration taken into consideration.

Although this alternative embodiment does not allow to adjust the direction of thrust S of the balancing device 10 with respect to the dead centre plane π, the same is in any case advantageous in all those cases in which one wishes to renounce to such a adjustment possibility in favor of a structural simplification of the hinge assembly 1 and of a cost reduction.

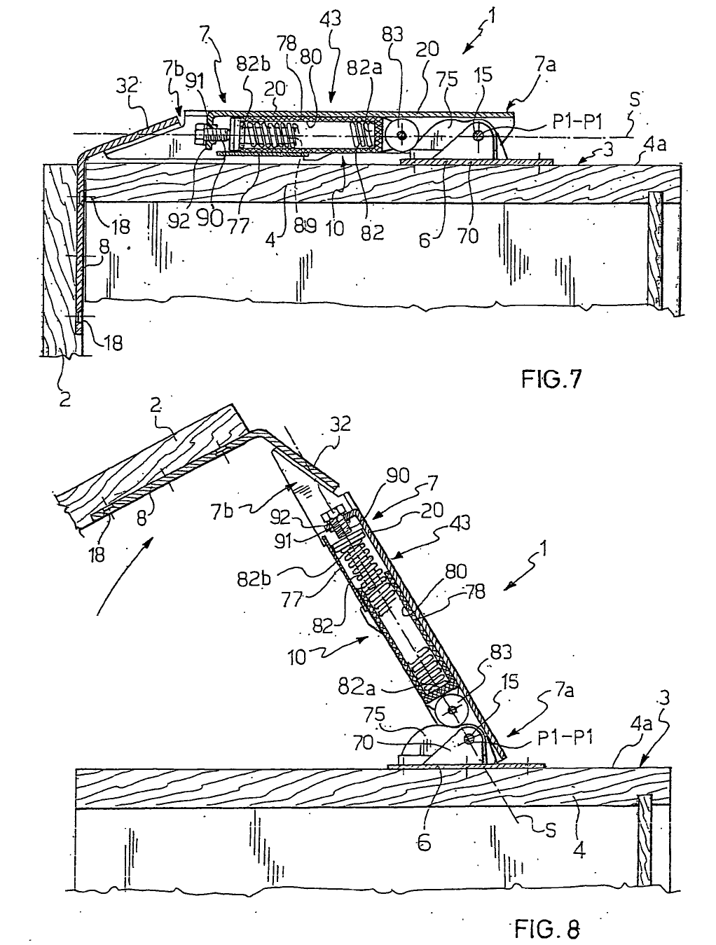

With reference to FIGS. 7-12 further preferred embodiments of the hinge assembly 1 according to the invention shall now be described.

In the following description and in such figures, the elements of the hinge assembly 1 which are structurally or functionally equivalent to those previously illustrated with reference to FIGS. 1-6 will be indicated with the same reference numerals and will not be described any further.

In the embodiment illustrated in FIGS. 7-9, the hinge assembly 1 achieves substantially the same technical effects and the same advantages as the previous embodiment with a mechanical construction and a cooperation of elements which differ at least in part.

In this case, the supporting base 6 is essentially constituted by a plate adapted to be fixed on the upper surface 4a of the furniture element 3 by means of a plurality of screws conventional per se and not shown.

The pin 15 defining the pivoting axis P1-P1 of the lifting lever 7 is in this case transversely supported by the supporting base 6 by means of two ribs 70, 71 perpendicularly extending from the base 6 and provided with respective through-holes 72, 73 for housing the pin 15.

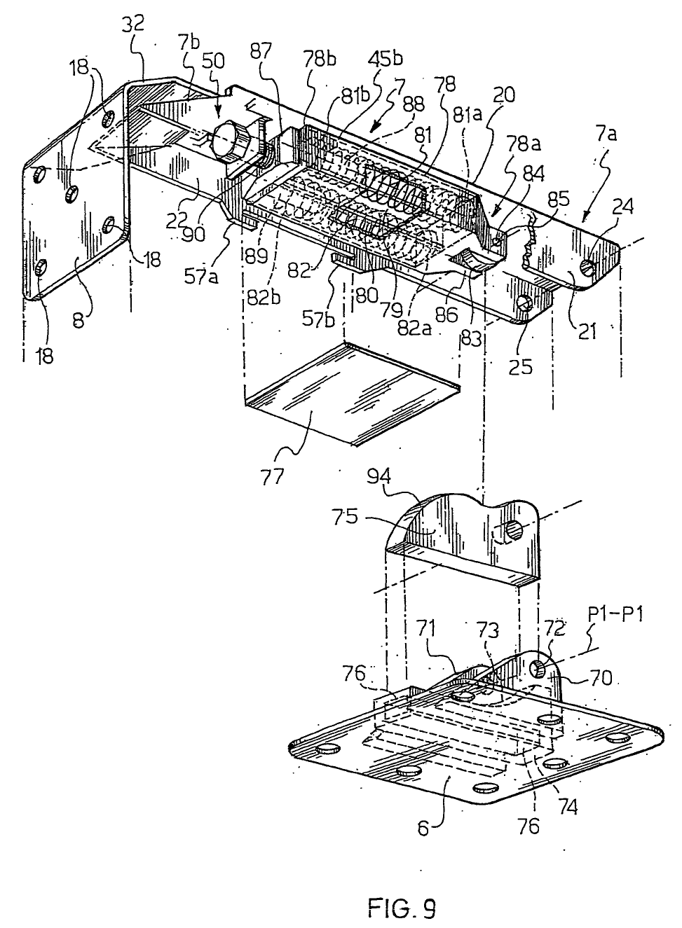

A basement 74 for supporting a cam element 75, the function of which shall be illustrated in greater detail later on, is also fixed or integrally formed on the supporting base 6 between the ribs 70, 71. To this end, the basement 74 is centrally provided with a groove 76 adapted to receive the lower part of the cam element 75, preferably with substantial shape coupling (see FIG. 9).

In this embodiment, the fastening element 8 associated to the panel 2 and the connecting arm 32 are formed integral with each other and are further integrally connected to the lifting lever 7, for example by means of conventional welding operations.

Preferably, the lifting lever 7 has also in this case a substantially C-shaped cross-section and is advantageously made of a suitable structural material, for example a metal, which can be shaped into the desired shape by means of conventional plastic deformation and shearing operations.

In this case, the width of the central wall 20 of the lifting lever 7 is preferably slightly greater than the overall transversal size defined by the ribs 70, 71 between which the cam element 75 is transversely supported, so that the lever 7 is capable to receive such components of the hinge assembly 1 in its internal space 23 when the hinge assembly is in the closing condition illustrated in FIG. 7.

In this case, therefore, the through-holes 24, 25 formed in the side walls 21, 22 of the lifting lever 7 are coaxial with the through-holes 72, 73 formed in the ribs 70, 71 extending in a cantilevered fashion from the supporting base 6.

In this way, the pin 15 is capable to engage both in the through-holes 72, 73 of the ribs 70, 71, and in the through-holes 24, 25 of the lifting lever 7 thus determining the pivoting thereof about the axis P1-P1.

In this preferred embodiment, the side walls 21, 22 of the R lever 7 are provided with respective pairs of grooved projections, of which only those indicated with 57a, 57b of the side wall 22 can be seen in FIGS. 7-9, constituting as many hooking and guided sliding means for a cover 77 adapted to at least partially close the lifting lever 7.

More specifically, the cover 77 defines a boxed structure which advantageously allows to guide the movements of the balancing device 10 along the direction of thrust S.

Also in this case the balancing device 10 preferably comprises a spring group 43.

Preferably, the latter comprises in turn a hollow body 78, in this case substantially parallelepipedic in shape, in which two substantially cylindrical housings 79, 80 are formed for receiving respective springs 81, 82 also in this case preferably of the coil type.

In this embodiment, the hollow body 78 is therefore slidably mounted in the housing space 23 defined within the lifting lever 7 and partially closed, as stated above, by the cover 77.

In the preferred embodiment illustrated in FIGS. 7-9, the hollow body 78 of the spring group 43 is provided with a roller 83 rotatably mounted on a respective supporting pin 84 transversely mounted between two parallel projections 85, 86 preferably integrally extending from an end 78a of the hollow body 78 proximal to the pivoting axis P1-P1 of the lifting lever 7.

The end 78a of the hollow body 78 is in this way preferably substantially fork-shaped.

In the preferred embodiment illustrated in FIGS. 7-9, the hollow body 78 of the spring group 43 is also provided with an end 78b distal with respect to the pivoting axis P1-P1 of the lifting lever 7 which is removably closed by a suitably shaped cap 87.

More specifically, the cap 87 is preferably provided with two spring-guiding stems 88, 89 each intended to extend in the housings 79, 80 formed in the hollow body 78 and intended to receive the springs 81, 82.

Each of the springs 81, 82 comprises a first thrusting end 81a, 82a, acting on the end of its housing 79, 80 proximal to the pivoting axis P1-P1 of the lifting lever 7 and a second reaction end 81b, 82b, reacting on the removable closing cap 87 of the end portion 78b of the hollow body 78 distal with respect to such an axis.

In this way, the roller 83 is urged by the spring 81, 82 towards the cam element 75 which is preferably shaped so that the thrust exerted by the balancing device 10 on the lifting lever 7 is capable to at least partially counterbalance the weight of the panel 2 during rotation of the lever 7 about the pivoting axis P1-P1.

Thanks to the aforementioned configuration of the cap 87, moreover, the spring-guiding stems 88, 89 engage in the reaction ends 81b, 82b of the springs 81, 82 so as to advantageously ensure a correct expansion/compression movement of the springs along the direction of thrust S exerted by the balancing device 10.

Preferably, the hollow body 78, the cap 87 and the roller 83 are made of a suitable plastics material so as to advantageously reduce both their weight and production cost.

In the preferred embodiment illustrated in FIGS. 7-9, the adjustment device 50 adapted to adjust the thrusting force exerted by the balancing device 10 on the lifting lever 7 comprises the removable closing cap 87 of the end portion 78b of the hollow body 78.

In this case, the cap 87 can be adjustably positioned along the longitudinal direction to move the abutment zone of the reaction ends 81b, 82b of the springs 81, 82 thanks to the action of an adjustment screw 90 rotatably mounted in the lifting lever 7 and cooperating in abutment relationship with the closing cap 87 of the hollow body 78.

In this way, it is advantageously possible to adjust the thrusting force exerted by the balancing device 10 on the lifting lever 7 by simply screwing or unscrewing the adjustment screw 90, i.e. by adjusting the degree of compression of the springs 81, 82.

To this end, the adjustment screw 90 is rotatably mounted in a respective threaded through-hole 91 formed in a tang 92 integrally extending from the central part 20 of the lifting lever 7 near its end portion 7b distal with respect to the pivoting axis P1-P1.

Preferably, the tang 92 forms an angle of about 90° with the central wall 20 of the lifting lever 7 and extends in the space 23 defined within said lever so that the threaded hole 91 substantially coaxially extends with the direction of thrust S of the balancing device 10 (see FIGS. 7 and 8).

Preferably, the adjustment screw 90 is provided with a head 93 for example shaped like a hexagonal nut or, alternatively, provided with a groove or another type of notch, for the engagement with a suitable tool, for example an Allen wrench or a screwdriver, for screwing in or unscrewing the adjustment screw 90.

In this preferred embodiment, moreover, the abutment element 53 adapted to limit the extraction of the closing cap 87 from the end 78b of the hollow body 78 housing the springs 81, 82 is advantageously constituted by the same adjustment screw 90 cooperating in abutment relationship with the aforementioned closing cap 87.

The adjustment screw 90 therefore carries out the dual advantageous function of an active element of the adjustment device 50 adapted to adjust the thrusting force exerted by the balancing device 10 on the lifting lever 7 and of an abutment element 53 adapted to limit the extraction of the closing cap 87 from the end 78b of the hollow body 78.

In the preferred embodiment illustrated in FIGS. 7-9, the cam element 75 mounted in the groove 76 formed in the supporting basement 74 extending close to the pivoting axis P1-P1 of the lifting lever 7, is provided at the top with a suitably shaped cam surface 94 adapted to constitute a rolling track for the roller 83.

By suitably shaping the cam surface 94 is advantageously possible to achieve an optimal adjustment of the balancing of the panel 2 at any intermediate position taken up by the panel itself during the entire rotation arc of the lifting lever 7.

In other words, it is possible in this way not only to have a very regular operation of the hinge assembly 1, without jerks or variations in the thrusting action during the movement of the panel 2, but also to achieve the aforementioned desired “self-supporting” effect of the panel 2 at any intermediate opening position.

From what has been outlined hereinabove the adjusting and operating modes of this second preferred embodiment of the hinge assembly 1 according to the invention are also immediately clear.

In adjusting mode, carried out with the hinge assembly open as illustrated in FIG. 8, the user or the furniture-maker are able to adjust both the force with which the hinge assembly 1 counterbalances the weight of the panel 2 by adjusting the compression degree of the springs 81, 82 by means of the adjustment device 50 (by acting on the adjustment screw 90).

Once the optimal adjustment of the hinge assembly 1 has been obtained according to the type and weight of the panel 2 to be articulated to the furniture element 3, the user should simply slightly lift the panel 2 to automatically trigger the operation of the hinge assembly 1.

As soon as the user lifts the panel 2, in fact, the balancing device 10 immediately carries out its thrusting action on the lifting lever 7 by means of the cap 87 urged by the springs 81, 82 towards the tang 92 integral with the lever itself during the rolling of the roller 83 on the cam surface 94 of the cam element 75 and continues its thrusting action during the entire opening or closing movement of the panel 2.

During lifting of the panel 2, moreover, the lifting lever 7 rotates about the pivoting axis P1-P1 and receives from the balancing device 10 a thrusting action adapted to counterbalance the weight of the panel itself by means of a thrusting action which can be adjusted by the user.

Also in this case, by suitably adjusting the balancing device 10, the thrusting action exerted by the same can be capable of substantially completely counterbalancing the weight of the panel 2 so that the user only has to apply a light lifting action to move the panel 2 upwards.

During such a movement, the panel 2 passes from a closing position of the furniture element 3 in which both the pivoting axis P1-P1 of the lifting lever 7 and the balancing device 10 are positioned above the upper surface 4a of the furniture element 3 (see FIG. 7), to an opening position in which the panel 2 is at least partially lifted with respect to the hinge assembly 1 and to the furniture element 3 (see FIG. 8).

In this preferred embodiment, the balancing device 10 and the lifting lever 7 are rotatably connected during the entire opening and closing movement of the panel 2.

Contextually, the hollow body 78 of the spring group 43 is slidably guided within the housing space 23 defined within the lifting lever 7 during such a movement which involves, among other things, the rolling of the roller 83 on the cam surface 94 (see FIGS. 7 and 8).

Also in this case it has been found that the articulation of the panel 2 to the furniture element 3 is guided in a very regular manner as required by the market.

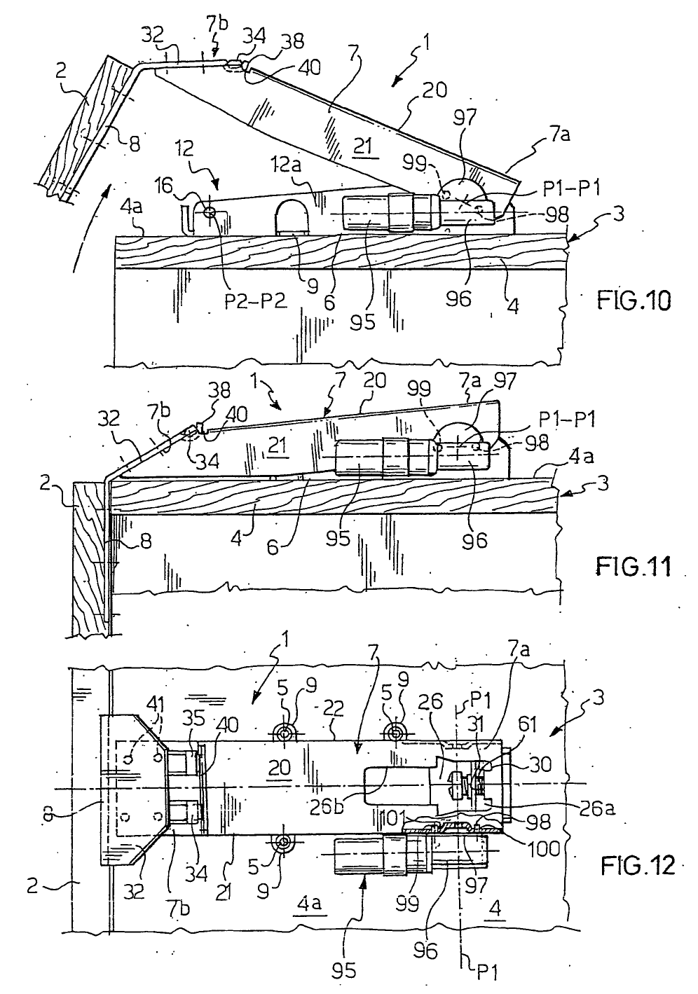

In a further preferred embodiment, illustrated in FIGS. 10-12 and particularly useful in the case in which one has to articulate a panel 2 of large size and/or weight to the furniture element 3, the balancing device 10 can comprise, as an alternative or in addition to the spring group 43, a motor group 95 acting on the lifting lever 7 to at least partially counterbalance the weight of the panel 2 during rotation of the lever 7 about the pivoting axis P1-P1.

In this preferred embodiment, the motor group 95 is preferably mounted on the upper wall 4 of the furniture element 3 and can be positioned without distinction on the right or on the left of the supporting base 6.

Preferably, the motor group 95 is provided with a reduction unit 96 provided in turn with a drive shaft, conventional per se and not shown, having a rotation axis substantially coinciding with the pivoting axis P1-P1 of the lifting lever 7.

In the preferred embodiment illustrated in FIGS. 10-12, the motor group 95 actuates, by means of the reduction unit 96, a disc 97 provided with a plurality of pegs, for example two pegs 98, 99, substantially parallel to each other and preferably positioned along a same diametral line of the disc 97.

The pegs 98, 99 carry out in this case the function of connection means of the motor group 95 with the lifting lever 7, which is moved by the drive shaft of the motor group 95 thanks to the engagement of the pegs 98, 99 in corresponding through-holes 100, 101 formed in the side wall 21 of the lifting lever 7 (see FIG. 12).

In this further embodiment, therefore, the at least partial counterbalancing action of the weight of the panel 2 carried out by the balancing device 10 can advantageously be totally or partially provided by the motor group 95 which can be coupled, if desired, with a spring group 43, for example of the type illustrated in FIGS. 1-6.

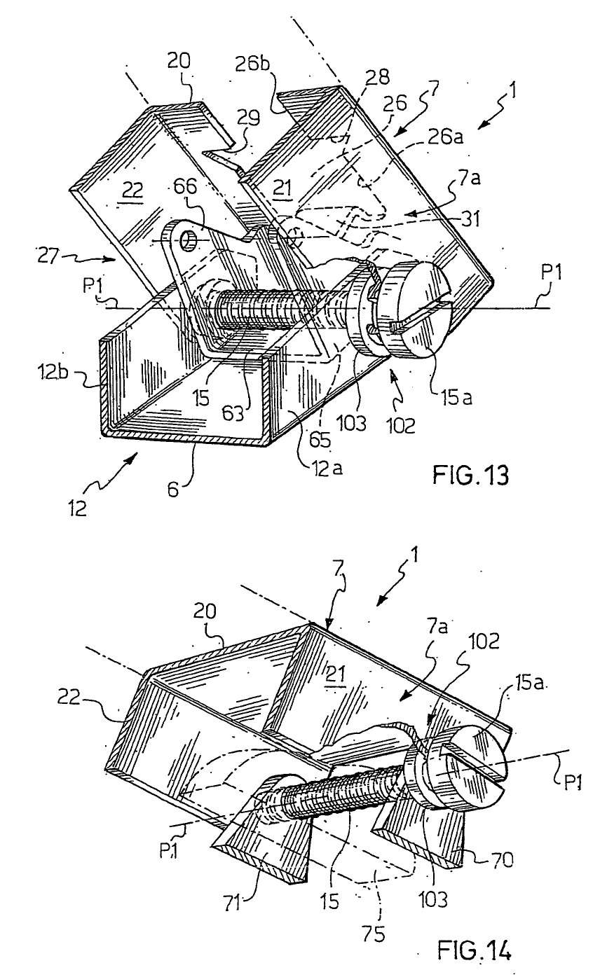

In further preferred embodiments of the invention, illustrated in FIGS. 13 and 14, the hinge assembly 1 of the invention can further comprise friction means 102 for adjusting the value of the lifting torque exerted by the lifting lever 7 to at least partially counterbalance the weight of the panel 2.

Preferably, the friction means 102 are suitably configured to adjust to a predetermined value, worked out at the design stage, the pivoting friction torque F of the lifting lever 7 pivoting about the pin 15 defining the pivoting axis P1-P1.

In this way, it is advantageously possible to make the so-called “balancing” of the panel 2 less critical and to ensure that the lifting thrust provided by the lifting lever 7 is always as close as possible to the force exerted by the weight of the panel 2.

In other words, by indicating as F the pivoting friction torque of the lifting lever 7, as W the torque due to the weight of the panel and tending to move the panel towards the closing position and as T the torque exerted by the balancing device 10 and tending to move the panel 2 towards the opening position, the hinge assembly 1 must be able to satisfy the following relation

|W−T|<F

In this specific preferred embodiment, therefore, the friction means 102 advantageously allows to regulate the value of the friction torque F making the “balancing” of the panel 2 less critical with same values of other torques T and W.

In the preferred embodiment illustrated in FIG. 13, the friction means 102 are preferably constituted by a ring 103, made of a suitable friction material, such as for example bronze or a suitable plastics material.

The ring 103 is coaxially mounted on the pin 15 and is placed, for example, between the side wall 21 of the lifting lever 7 and the side wall 12a of the supporting element 12.

In the preferred embodiment illustrated in FIG. 14, on the other hand, the ring 103 L 0 made of a suitable friction material is coaxially mounted on the pin 15 and placed, for example, between the side wall 21 of the lifting lever 7 and the rib 70 extending in a cantilevered fashion from the supporting base 6.

In both cases, the pin 15 is preferably at least partially threaded and is in screwing engagement in housing holes 13-24 or 72-24 also preferably threaded.

Preferably, the pin 15 is provided with a head 15a having a groove or another type of notch or, alternatively, shaped in a suitable manner, for example like a hexagonal nut, for the engagement with a suitable tool, for example a screwdriver or an Allen wrench, for screwing or unscrewing the pin 15.

In this preferred embodiment, the friction torque F can therefore be adjusted by simply screwing or unscrewing the partially threaded pin 15 so as to move the side wall 21 of the lifting lever 7 closer to the side wall 12a of the supporting element 12 or closer to the rib 70 extending from the supporting base 6 by the desired amount, compressing the ring 103 to a lesser or greater extent which will consequently develop a higher or lower friction.

Clearly, the man skilled in the art can bring modifications and variants to the invention described above in order to satisfy specific and contingent application requirements, such modifications and variants in any case being covered by the scope of protection as defined by the subsequent claims.

Thus, for example, the balancing device 10 can comprise as thrusting element means different from the spring group 43 provided that such means is capable of exerting an adequate thrusting action on the lifting lever 7. In the same way, the same spring group 43 can comprise suitable spring means different from those illustrated merely as an example, such as for example gas springs, or whatever other spring means as may suitably be selected by a man skilled in the art in order to satisfy specific application requirements.

1. Hinge assembly (1) for the articulated connection of a vertically opening panel (2) to a furniture element (3) between a closing position and an opening position in which the panel (2) is at least partially lifted with respect to the hinge assembly (1) and to the furniture element (3), comprising:
a supporting base (6);
a lifting lever (7) operatively connected to the panel (2) and hinged to the supporting base (6) about a pivoting axis (P1-P1) between said closing and opening positions of the panel (2);
a balancing device (10) acting on the lifting lever (7) to at least partially counterbalance the weight of the panel (2) during rotation of the lever (7) about said pivoting axis (P1-P1);
characterized in that in the mounting position of the hinge assembly (1) the pivoting axis (P1-P1) of the lifting lever (7) and said balancing device (10) are positioned above an upper surface (4a) of the furniture element (3).

2. Hinge assembly (1) according to claim 1, wherein said balancing device (10) and said lifting lever (7) are mounted above said supporting base (6).

3. Hinge assembly (1) according to claim 1, wherein said lifting lever (7) is operatively connected to the panel (2) by means of at least one fastening element (8) associated to the lifting lever (7) by means of a connecting arm (32).

4. Hinge assembly (1) according to claim 3, wherein said at least one fastening element (8) is constituted by a portion of the connecting arm (32) distal with respect to the lifting lever (7).

5. Hinge assembly (1) according to claim 3, wherein the lifting lever (7) is provided with hooking means (33) adapted to cooperate with a portion of the connecting arm (32) proximal to the lever (7).

6. Hinge assembly (1) according to claim 3, wherein the connecting arm (32) is integrally formed with the lifting lever (7).

7. Hinge assembly (1) according to claim 1 or 4, wherein said at least one fastening element (8) is constituted by a substantially plate-shaped element adapted to be laterally associated to the panel (2) at an upper end (2a) thereof.

8. Hinge assembly (1) according to claim 1, wherein the balancing device (10) comprises a spring group (43) adapted to exert a thrusting action on the lifting lever (7) to at least partially counterbalance the weight of the panel (2) during rotation of the lifting lever (7) about said pivoting axis (P1-P1).

9. Hinge assembly (1) according to claim 8, wherein said spring group (43) comprises at least one spring (44, 81, 82) received in a hollow supporting body (45, 78).

10. Hinge assembly (1) according to claim 9, wherein said hollow body (45) is hinged to the supporting base (6) at an end of the hollow body (45) distal with respect to the lifting lever (7).

11. Hinge assembly (1) according to claim 10, wherein said hollow body (45) is hinged to at least one supporting wall (12a, 12b) extending laterally to the supporting base (6).

12. Hinge assembly (1) according to claim 11, wherein said supporting wall (12a, 12b) integrally extends from the supporting base (6).

13. Hinge assembly (1) according to claim 1 or 8, wherein said balancing device (10) comprises an adjustment device (50) for adjusting the thrusting force exerted by the balancing device (10) on the lifting lever (7).

14. Hinge assembly (1) according to claims 9 and 13, wherein said adjustment device (50) comprises a cap (51, 87) for closing the distal end (45b, 78b) of the hollow body (45, 78), said cap being adjustably positionable along the axial direction and being adapted to cooperate in abutment relationship with a free end of said at least one spring (44, 81, 82).

15. Hinge assembly (1) according to claim 14, further comprising at least one abutment element (54a, 54b, 90) adapted to limit the extraction of the closing cap (51) from the distal end (45b, 78b) of the hollow body (45, 78) housing said at least one spring (44, 81, 82).

16. Hinge assembly (1) according to claim 15, wherein said at least one abutment element (54a, 54b) integrally extends from the supporting base (6).

17. Hinge assembly (1) according to claim 15, wherein said at least one abutment element (90) is constituted by an adjustment screw rotatably mounted in the lifting lever (7) and cooperating in abutment relationship with the closing cap (87) of the hollow body (78).

18. Hinge assembly (1) according to claim 1 or 8, wherein said balancing device (10) is at least temporarily housed in a respective housing space (23) defined within the lifting lever (7) during rotation of the lifting lever (7) about said pivoting axis (P1-P1).

19. Hinge assembly (1) according to claim 18, wherein said spring group (43) is slidably mounted in said housing space (23) defined within the lifting lever (7).

20. Hinge assembly (1) according to claim 19, wherein the hollow supporting body (78) of the spring group (43) is provided with a roller (83) rotatably mounted at an end of the hollow body (78a) proximal to the pivoting axis (P1-P1) of the lifting lever (7).

21. Hinge assembly (1) according to claim 20, wherein said roller (83) is urged by said at least one coil spring (81, 82) towards a cam element (75) shaped so that the thrust exerted by the balancing device (10) on the lifting lever (7) is capable to at least partially counterbalance the weight of the panel (2) during rotation of the lever (7) about said pivoting axis (P1-P1).

22. Hinge assembly (1) according to claim 21, wherein said cam element (75) is mounted on said supporting base (6) close to the pivoting axis (P1-P1) of the lifting lever (7).

23. Hinge assembly (1) according to claim 9, wherein said spring group (43) comprises at least one pushing element (59) slidably mounted in said hollow supporting body (45) and urged by said at least one spring (44) towards the lifting lever (7).

24. Hinge assembly (1) according to claim 9 or 23, wherein said spring group (43) comprises at least one spring-guiding stem (60, 88, 89) extending from said closing cap (51, 87) of the hollow body (45, 78) and/or from said pushing element (59).

25. Hinge assembly (1) according to claim 1, further comprising an angular adjustment device (27) for adjusting the angular position of the direction of thrust (S) exerted by the balancing device (10) on the lifting lever (7) with respect to a dead centre plane (π) passing through a pivoting axis (P2-P2) of the balancing device (10) and through the pivoting axis (P1-P1) of said lever (7).

26. Hinge assembly (1) according to claim 25, wherein said angular adjustment device (27) comprises a supporting body (58) hinged to the supporting base (6) about the pivoting axis (P1-P1) of the lifting lever (7) and operatively arranged between said lever (7) and the balancing device (10).

27. Hinge assembly (1) according to claim 26, wherein the supporting body (58) of the angular adjustment device (27) is angularly displaceable with respect to the lifting lever (7).

28. Hinge assembly (1) according to claim 26 or 27, wherein the angular adjustment device (27) comprises adjustment means (61) for regulating in an adjustable manner the angular position of said supporting body (58) with respect to the lifting lever (7).

29. Hinge assembly (1) according to claim 26 or 27, further comprising abutment means (28, 29, 31) for limiting the angular displacement of the angular adjustment device (27) with respect to the lifting lever (7).

30. Hinge assembly (1) according to claim 26, wherein the balancing device (10) acts upon a pin (64) transversely mounted in said angular adjustment device (27).

31. Hinge assembly (1) according to claims 9 and 30, wherein said pin (64) is slidably mounted along the longitudinal direction in an end of the hollow body (45) proximal to L 5 the lifting lever (7) of the balancing device (10) during rotation of the lifting lever (7) about the pivoting axis (P1-P1) thereof.

32. Hinge assembly (1) according to claim 31, wherein the hollow body (45) of the balancing device (10) is provided with means (67, 68) for guiding the axial sliding of said transversal pin (64).

33. Hinge assembly (1) according to claim 1 or 25, wherein the direction of thrust (S) exerted by the balancing device (10) forms an angle of from about 0° to about 30° with respect to said dead centre plane (π).

34. Hinge assembly (1) according to claim 25, wherein said angular adjustment device (27) is housed in a respective housing space (23) defined within the lifting lever (7).

35. Hinge-assembly (1) according to claim 1, wherein said balancing device (10) comprises a motor group (95) acting on the lifting lever (7) to at least partially counterbalance the weight of the panel (2) during rotation of the lever (7) about said pivoting axis (P1-P1).

36. Hinge assembly (1) according to claim 1, further comprising friction means (102) to adjust the value of the lifting torque exerted by the lifting lever (7) to at least partially counterbalance the weight of the panel 2.

37. Furniture element (3) comprising a panel (2) articulated to the furniture element (3) by means of at least one hinge assembly (1) according to any one of the previous claims.

38. Furniture element (3) according to claim 37, wherein said at least one hinge assembly (1) is mounted above an upper surface (4a) of said element.

39. Furniture element (3) according to claim 37, wherein the hinge assembly (1) comprises a lifting lever (7) operatively associated to the panel (2) by means of at least one fastening element (8) associated to the panel (2) at an upper end (2a) thereof.

40. Furniture element (3) according to claim 39, wherein the fastening element (8) is constituted by a substantially plate-shaped element received in a respective housing seat (19) laterally formed in the panel (2).
